(19) United States
(12) Patent Application Publication
(10) Pub. No.: US 2020/0324492 A1
(43) Pub. Date: Oct. 15, 2020

(54) SEALING TOOL ASSEMBLY

(71) Applicant: ISHIDA EUROPE LIMITED, Birmingham, West Midlands (GB)

(72) Inventors: David MORGAN, Bournemouth (GB); Lee VINE, Lytchett Matravers (GB)

(73) Assignee: ISHIDA EUROPE LIMITED, Birmingham, West Midlands (GB)

(21) Appl. No.: 16/305,802

(22) PCT Filed: Jun. 2, 2017
(86) PCT No.: PCT/GB2017/051588

§ 371 Date: Nov. 29, 2018

(30) Foreign Application Priority Data
Jun. 2, 2016 (GB) 1609681.0

(51) Int. Cl. B29C 65/74; B29C 65/18; B29C 65/00; B65B 51/10; B65B 7/28; B65B 61/06

(52) U.S. Cl. CPC B29C 65/745; B29C 65/18; B29C 66/53461; B65B 61/06; B65B 7/2878; B29C 66/849; B65B 51/10

(57) ABSTRACT

A sealing tool module (100) is provided. The sealing tool module (100) comprises a housing; a heat-sealing plate (120); and a first actuator for use in moving said heat-sealing plate between a retracted position and a heat-sealing position, the first actuator being movably mounted with respect to the housing; wherein the first actuator is a first shaft on the end of which the heat-sealing plate (120) is mounted, the first shaft being axially movable relative to the housing; and the first shaft comprises a channel configured to guide wiring through the housing and to the rear of the heat-sealing plate (120). A sealing tool assembly (1) for heat sealing a cover film to a container is also provided. The assembly comprises a sealing module support (10) having a plurality of openings therethrough and a plurality of sealing modules each disposed in a respective one of the plurality of openings and configured to independently perform heat sealing, wherein each of the plurality of sealing modules is removable from the sealing module support independently of the other sealing modules.

### FIELD OF THE INVENTION

The invention relates to a sealing tool assembly configured to heat seal a cover film to a plurality of containers.

### DESCRIPTION OF BACKGROUND ART

Sealing tools for performing a top seal as known in the art generally comprise upper and lower tools. Typically the lower tool will be configured to hold a plurality of trays and lift them towards the upper tool. The upper tool will typically feature a plurality of integrally formed sealers, each configured to weld film to the rim of a respective one of the trays and then cut around the edge of the tray to complete a top seal.

Each upper tool may have many sealers integrally formed within it, and under normal operation it is inevitable that occasionally a sealer will fail. Sealing tools have a significant failure rate due to their reliance on springs in the actuation of the sealer and use of electrical components in the presence of moisture. When a sealer fails, the top tool must be removed for repair, stopping the production line. Such stoppages are very expensive to the operator.

It is therefore desirable to provide a sealing tool assembly which solves the above described problem.

### SUMMARY OF INVENTION

In accordance with a first aspect of the present invention there is provided a sealing tool module comprising a housing; a heat-sealing plate; and a first actuator for use in moving said heat-sealing plate between a retracted position and a heat-sealing position, the first actuator being movably mounted with respect to the housing; wherein the first actuator is a first shaft on the end of which the heat-sealing plate is mounted, the first shaft being axially movable relative to the housing; and the first shaft comprises a channel configured to guide wiring through the housing and to the rear of the heat-sealing plate. The sealing module according to the first aspect facilitates the provision of power to the heat sealing plate without exposure of the any associated wiring by having a channel in the first shaft which guides wiring down through sealing tool module to the rear of the heat-sealing plate. Such a sealing tool module advantageously reduces the failure rate of a sealing tool.

Typically, the sealing tool according to the first aspect will be provided in, a sealing tool assembly for heat sealing a cover film to a container. A sealing tool assembly is provided according to a second aspect, the assembly comprising a sealing module support having a plurality of openings therethrough, and a plurality of sealing modules, each disposed in a respective one of the plurality of openings and each configured to independently perform heat sealing, wherein each sealing module comprises a housing, a heat-sealing plate, and a first actuator for use in moving said heat-sealing plate between a retracted position and a heat-sealing position, the first actuator being movably mounted in the housing, and wherein each of the plurality of sealing modules is removable from the sealing module support independently of the other sealing modules.

Having a sealing tool assembly in which each of the plurality of sealing modules is removable is advantageous in that if one of the sealing modules were to fail, it can be quickly exchanged for a functioning module and the machine placed back into production. The faulty module can be repaired offline without impacting production efficiency. This is because only the faulty module requires replacing rather than an entire upper tool, or, alternatively, the faulty module could be removed to be repaired while the remaining sealing modules continue to be used.

A number of preferable features are also provided, which may apply to either the sealing tool module or the sealing tool assembly according to the first or second aspect of the invention.

In some embodiments, it is desirable to reduce the failure rate through use of pneumatics or hydraulics rather than conventional springs. Therefore, preferably the movement of the heat-sealing plate between the retracted position and the heat-sealing position is pneumatically or hydraulically controlled and/or movement of the heat-sealing plate between the heat-sealing position and the retracted position is pneumatically or hydraulically controlled.

Preferably, each sealing module is insertable into a respective opening of the sealing module support, and retainable there by engagement between its housing and the sealing module support via at least one retention member (for example a removable retainer inserted between the housing and the sealing module), and more preferably the module is insertable up into the opening and removable down through the opening. Advantageously, a removable retainer engaging the housing allows a sealing module to be securely held during operation while facilitating a swift release of the sealing module from the sealing module support. This decreases costly service time of the sealing tool assembly and can increase uptime. While preferable, it is foreseen that sealing tool assemblies may alternatively use sealing modules which, for example, slot into the sealing module support.

In some embodiments the first actuator is a first shaft on the end of which the heat-sealing plate is mounted, the first shaft being axially movable relative to the housing. While preferable, other forms of mounting and actuating are foreseen, for example, the heat-sealing plate may be held from the side. Preferably, the first shaft comprises a channel configured to guide wiring through the housing and to the rear of the heat-sealing plate. Preferably the channel is internal to the first shaft, and preferably extends internally along the entire length of the shaft. For example, the shaft may be hollow along its length. In alternative embodiments, the shaft is solid and wiring does not pass through the housing. Embodiments in which the shaft is hollow are particularly preferable because it keeps wiring away from the sealing area and away from potential damage which could lead to the occurrence of a fault.

Once a film is sealed to a tray, the film generally needs cutting before the tray can be packaged. Therefore, preferably, each sealing module further comprises a cutting blade, and a second actuator movably mounted within the housing for use in moving the cutting blade between a retracted position and an extended position, wherein the cutting blade extends substantially around the perimeter of the heat-sealing plate. This advantageously allows each sealing module to seal film to a tray and also to cut the film, removing the requirement for any downstream cutting. While preferable, embodiments are foreseen in which the sealing module performs sealing only. As with the heat sealing plate, preferably the actuation of the cutting blade is pneumatically or hydraulically controlled.

In particularly preferable embodiments, the second actuator is a second shaft on the end of which the cutting blade is mounted, and moving the cutting blade comprises axially moving the second shaft, and the second shaft is axially movable relative to the first shaft and the housing. Mounting the heat-sealing plate and cutting blade on coaxial shafts allows for a very compact arrangement that minimises the size of each sealing module.

For sealing tools known in the art, upper tools are generally configured to perform only one type of top seal. The different types of top seal generally used are ‘inside’ and ‘outside’ cuts. An inside cut is a type of top seal in which the film sealed to the rim of the tray is approximately the same size as the tray, or smaller, and an outside cut is a type of top seal in which the film extends out a short distance beyond the rim of the tray. These two types if packaging format require different relative movements of the heater and cutting blade. This would normally require the manufacture of two different sealing modules to achieve the different movements. Therefore, in preferable embodiments, the sealing module may be switched from a first configuration to a second configuration, wherein in a first configuration the second shaft has a first movable range, and in the second configuration the second shaft has a second movable range different from the first movable range. Changing the movable range of the second shaft allows the same sealing module to perform different cutting strokes by changing the configuration which reduces manufacture cost.

In embodiments in which the sealing module may be changed between different configurations, preferably the second shaft is rotatable relative to the housing so as to switch between the first configuration and the second configuration. Preferably, each sealing module further comprises a stop, the stop being movable with respect to the housing between first and second positions for switching between the first configuration and the second configuration, the stop causing engagement between the second shaft and the housing in at least one of the first and second positions, and thereby affecting the movable range of the second shaft. In some such embodiments, in the first configuration a stop on one of the second shaft or an interior surface of the housing is received in a recess in the other of the second shaft or the interior surface of the housing thereby permitting the first movable range of the second shaft and in the second configuration the stop on one of the second shaft or the interior surface of the housing is not received in the recess in the other of the second shaft or the interior surface of the housing thereby permitting the second movable range of the second shaft. The use of a stop which may or may not be received by a corresponding recess represents a convenient way of modifying the movable range of the second shaft, and thereby permitting different sealing strokes. While the use of a stop is preferable, the movement range of the second shaft may alternatively be restricted by any means.

In embodiments in which the movable range of the second shaft may be changed, preferably in use the first and second configurations are used for different sealing-and-cutting strokes, and preferably the first configuration is an outside-cut configuration and the second configuration is an inside-cut configuration. Preferably, in an outside-cut configuration the first actuator is configured to move the heat-sealing plate from a first heat-sealing plate position to a second heat-sealing plate position lower than the first heat-sealing plate position, and the second actuator is configured to move the cutting blade from a first cutting blade position to a second cutting blade position lower than the first cutting blade position, wherein in the second cutting blade position a cutting edge of the cutting blade is lower than the heat-sealing plate in the second heat-sealing plate position, wherein, in use, the heat-sealing plate is moved from the first heat-sealing plate position to the second heat-sealing plate position so as to perform a heat seal, and the cutting blade is moved from the first cutting blade position to the second cutting blade position so as to perform a cut, and wherein the heat-sealing plate arrives at the second heat sealing position before the cutting blade arrives at the second cutting blade position so that the sealing module performs a seal-cut stroke. Preferably, in an inside-cut configuration the first actuator is configured to move the heat-sealing plate from a first heat-sealing plate position to a second heat-sealing plate position lower than the first heat-sealing plate position, and the second actuator is configured to move the cutting blade from a first cutting blade position to a third cutting blade position lower than the first cutting blade position, wherein in the third cutting blade position a cutting edge of the cutting blade is higher than the sealing plate in the second sealing plate position, wherein, in use, the cutting blade is moved from the first cutting blade position to the third cutting blade position to perform a cut, and the heat-sealing plate is moved from the first heat-sealing plate position to the second heat-sealing plate position to perform a seal, and wherein the cutting blade arrives at the third cutting blade position before the heat sealing plate arrives at the second heat-sealing plate position so that the sealing module performs a cut-seal stroke. While these sealing-and-cutting stokes are preferable, other embodiments are foreseen, for example, the different movement ranges could be used to perform the same sealing-and-cutting stoke but on trays of different heights.

In accordance with a third aspect of the invention, there is provided a second sealing tool module, which, for example, may be suitable for use in the sealing tool assembly of the second aspect. The sealing tool module comprises a housing; a heat-sealing plate; a first actuator for use in moving said heat-sealing plate between a retracted position and a heat-sealing position, the first actuator being movably mounted with respect to the housing; a cutting blade, the cutting blade extending substantially around the perimeter of the heat-sealing plate; and a second actuator movably mounted within the housing for use in moving the cutting blade between a retracted position and an extended position; wherein the sealing module may be switched from a first configuration to a second configuration, wherein in a first configuration the second actuator has a first movable range, and in the second configuration the second actuator has a second movable range different from the first movable range.

Providing a means for changing the movable range of the second shaft allows the same sealing module to perform either an inside cut stroke or an outside cut stroke by changing the configuration, which reduces manufacture cost by requiring only a single type of sealing tool module to be produced.

It will be appreciated that all of the features discussed above with respect to the sealing modules of the first and second aspects may be incorporated into the sealing module of the third aspect.

### BRIEF DESCRIPTION OF THE DRAWINGS

Embodiments of the present invention will now be described with reference to the accompanying drawings in which:

FIG. 1 is a cross-section of a portion of a sealing module support and lower tool according to an embodiment of the present invention;

FIGS. 2A to 2D are cross-sections of a sealing module according to an embodiment configured to be mounted on the sealing module support shown in FIG. 1, with FIGS. 2A to 2C showing the sealing module in a first configuration, and FIG. 2D showing the sealing module in a second configuration;

FIGS. 3A and 3B are top and bottom perspective views respectively of the sealing module of FIG. 2, without a heat-sealing plate or cutting blade assembly;

FIGS. 4A and 4B are top and bottom perspective cut-away views respectively of the sealing module of FIGS. 2, 3A and 3B, without the heat-sealing plate or cutting blade assembly;

FIG. 5 is a cross-section showing the sealing module of FIG. 2 mounted on the sealing module support of FIG. 1;

FIGS. 6A and 6B are cross-sections of a sealing tool assembly formed of modules according to FIG. 2 mounted in a sealing module support according to FIG. 1, shown in first and second positions respectively

FIG. 7 shows a partial section of a sealing module according to an embodiment.

### DETAILED DESCRIPTION

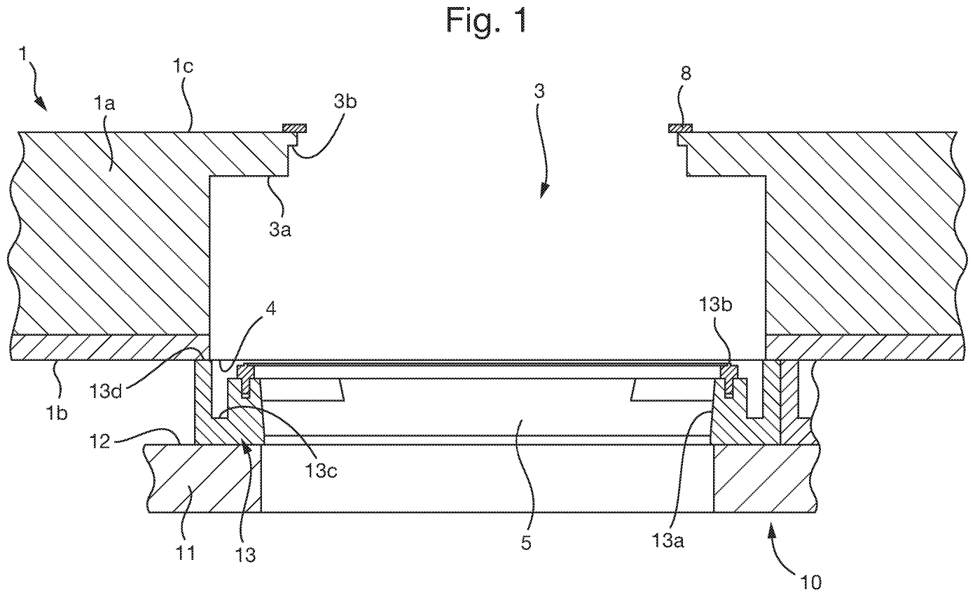

The sealing tool shown in the Figures comprises a sealing module support section 1 as shown in FIG. 1. The sealing module support section takes the place of an upper tool in a conventional sealing tool. The sealing module support section 1 comprises a plurality of openings 3 in the form of apertures through the main body 1a of the support 1. The sealing module support 1 is configured to be held, in use, by a heat sealing apparatus (not shown) for use in heat sealing a cover film to a container, such as a tray 5 of food product. The sealing module support 1 has a lower surface 1b that is substantially horizontal and is configured to engage with a lower tool 10, which is held, in use, below the sealing module support 1 by the heat sealing apparatus. The sealing module support further comprises a substantially horizontal upper surface 1c.

The lower tool comprises a main body 11, which has a substantially horizontal upper surface 12, and a plurality of tray holders 13 extending above the horizontal upper surface 12 of the main body 11. Each tray holder 13 is positioned on the upper surface 12 of the lower tool 10 such that it is directly below a corresponding one of the plurality of openings 3 in the sealing module support section 1.

Each tray holder 13 is configured to hold a respective tray 5 during the sealing process. A tray holder 13 comprises a receiving section 13a shaped to receive the lower portion of a tray 5. The tray holder further comprises a first lip 13b extending up and around the generally rectangular periphery of the receiving section 13a and configured to hold the tray around its circumference by a protruding portion commonly found on trays 5 of food product. Each tray holder further comprises a large groove 13c which extends generally rectangularly around the lip 13b at a distance spaced away from the edge of a tray disposed in the receiving section 13a. The tray holder further comprises a second lip 13d which runs around the large groove 13c and extends up higher than the first lip 13b.

When both the sealing module support section 1 and the lower tool 10 are installed in the heat sealing apparatus, and when the heat sealing apparatus holds them in an open position, a film 4 runs horizontally between the sealing module support 1 and the lower tool 10. In use, the lower tool, which comprises the plurality of tray holders 13, each holding a respective tray 5, is configured to be brought up into engagement with the sealing module support section 1. The process of raising the lower tool into engagement with the sealing module support section 1 clamps the film 4 between them. In the engagement position, the portion of the lower surface 1b of the sealing module support 1 around the periphery of each aperture 3 engages the upper surface of the second lip 13d of its respective one of the plurality of tray holders 13, with the film 4 being held therebetween.

Each opening 3 through the sealing module support 1 is a generally rectangular aperture. The upper surface 1c of the sealing module support projects partially into the aperture about the entire circumference. This overhang 3a results in the opening in the lower surface 1b of the sealing module support 1 being larger than the opening in the upper surface 1c. The overhanging portion 3a itself features a second, smaller projection into the aperture creating a second, smaller overhang 3b. Each opening 3 through the sealing module support is configured to receive a respective sealing module 100, which will now be described in detail.

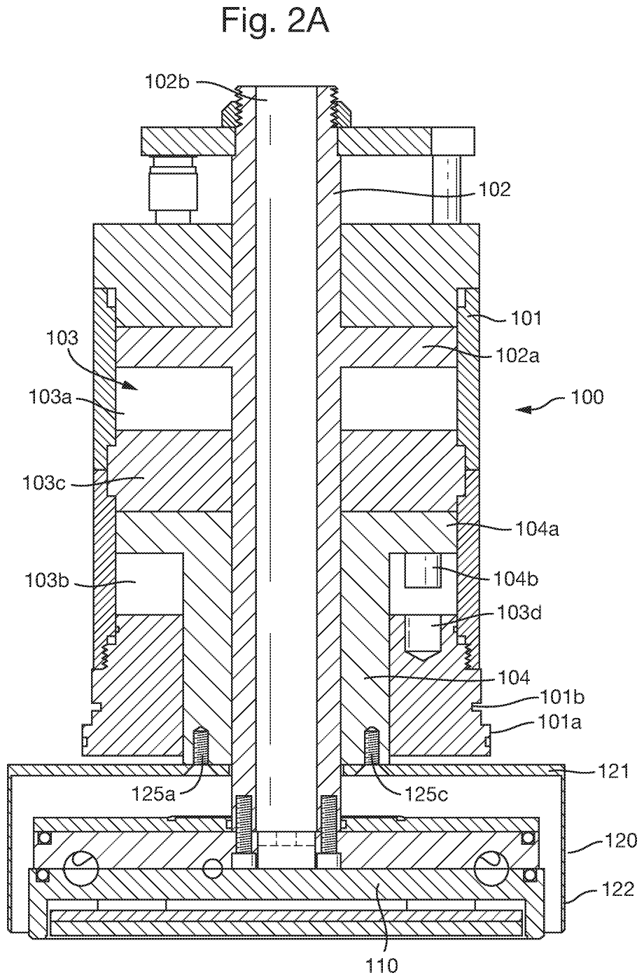

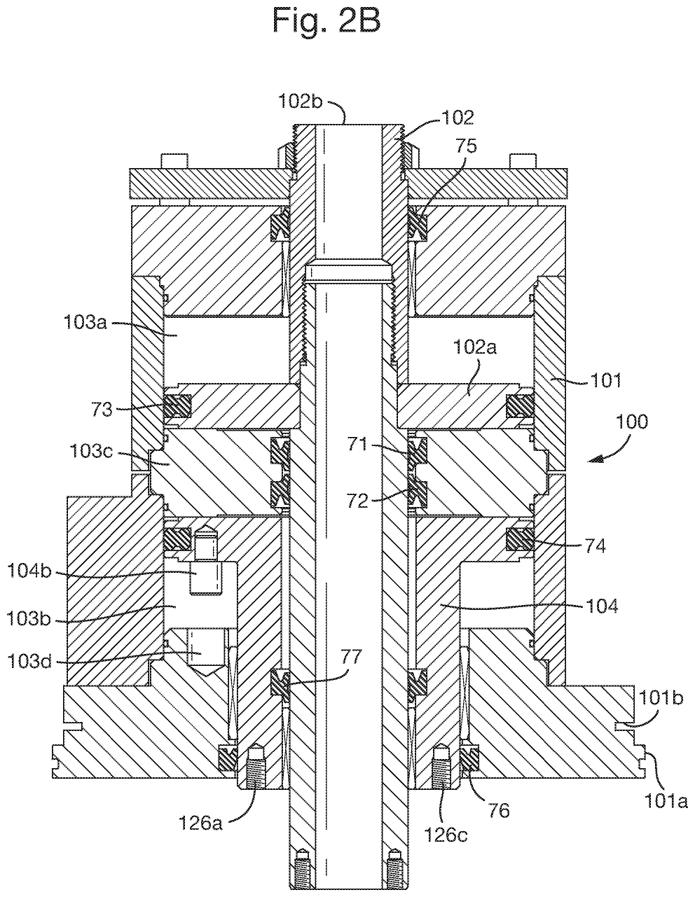

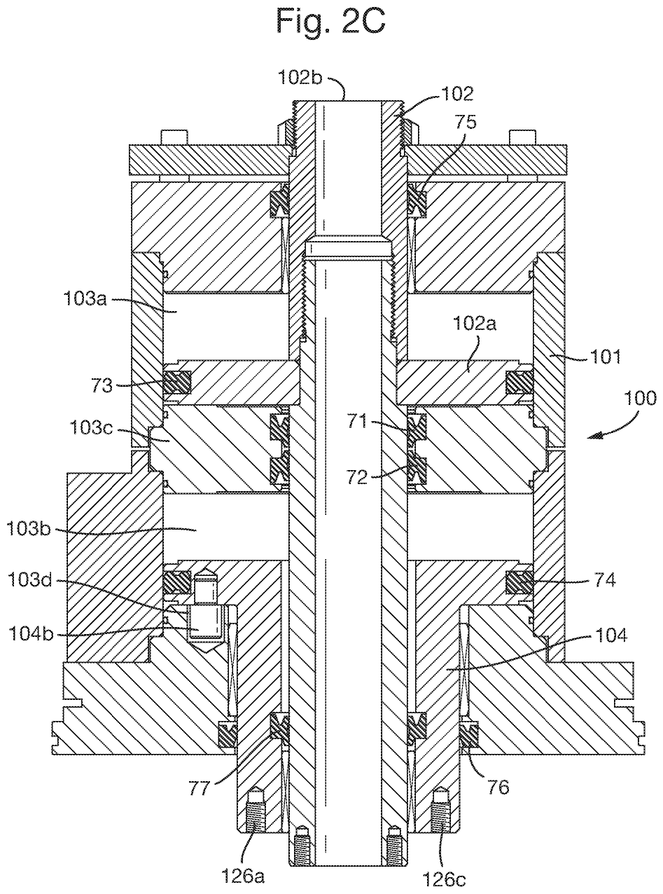

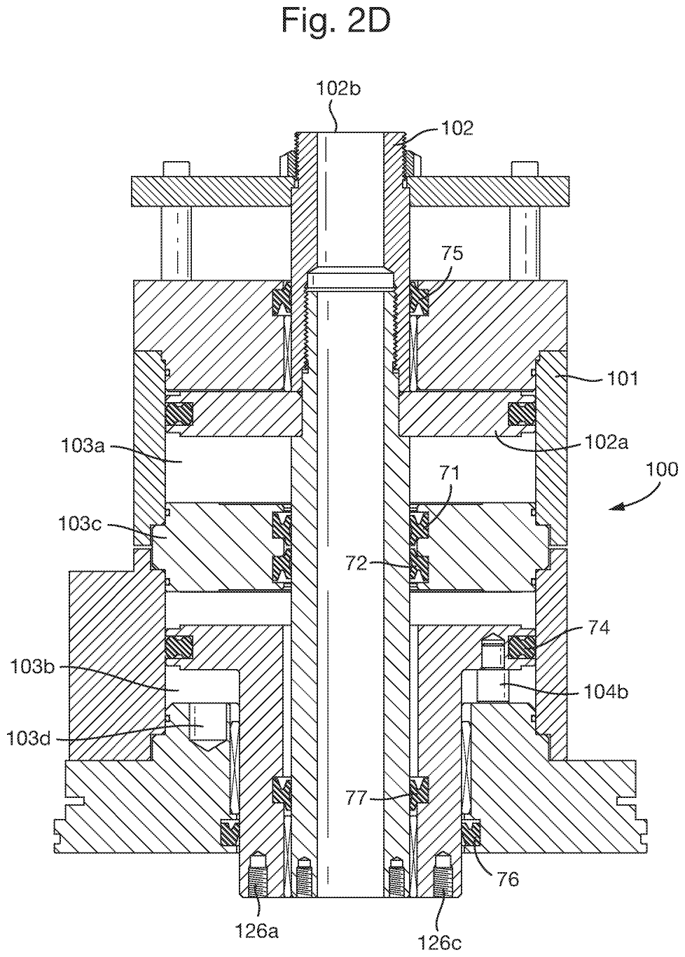

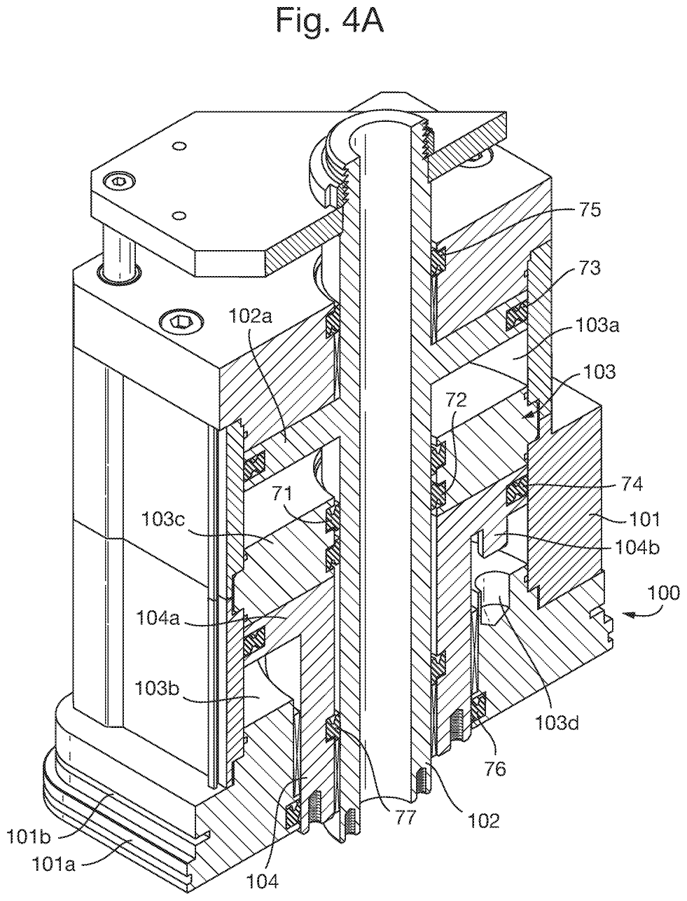

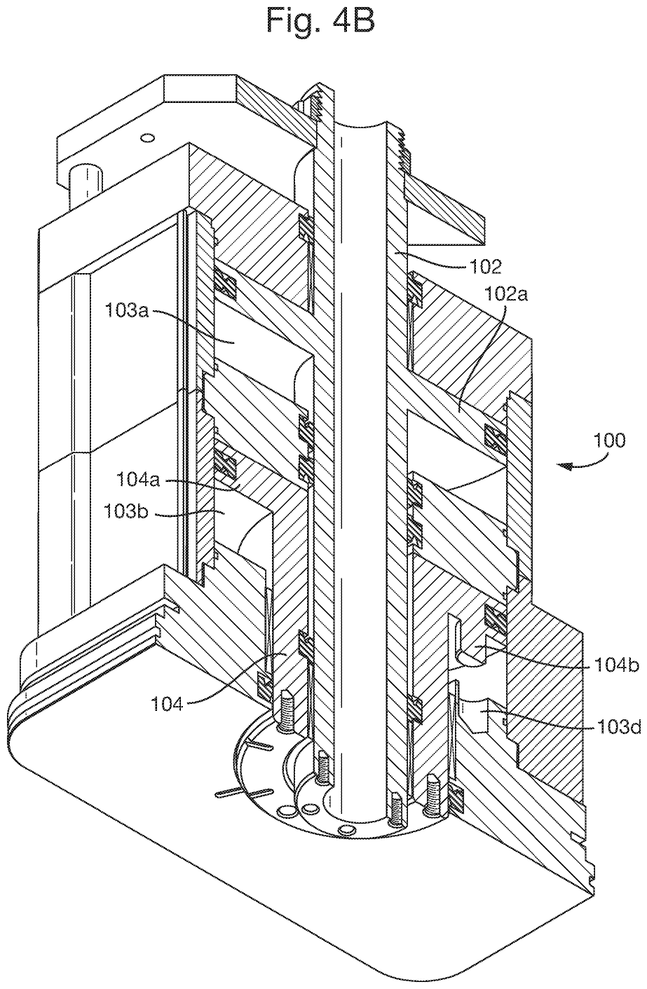

As shown in FIGS. 2A to 4B, each sealing module 100 comprises an external housing 101. The external housing is generally cuboidal in shape and has a vertical height, when installed in use, of approximately 19.5 cm, a width of 11.0 cm, and a depth of 14.5 cm. Each module has an interior chamber 103 that is generally cylindrical in shape. A first cylindrical shaft 102, having a diameter of approximately 3.2 cm extends vertically through the top surface of the external housing, down through the interior of the external housing 101, running coaxially along the cylindrical interior chamber 103, and through the bottom surface of the external housing. The length of the first shaft 102 exceeds the height of the external housing 101 such that a length of shaft protrudes a short distance out of the top and bottom surfaces of the external housing 101. The first shaft 102 enters the external housing through an upper opening, the upper opening having about its periphery a ring seal 75 which engages with the surface of the second shaft 102.

The interior chamber 103 is divided into upper and lower chambers 103a, 103b by an interior separator 103c extending radially inwardly from the interior wall towards the surface of the first shaft 102. The interior separator has upper and lower seals 71, 72 which each engage with the surface of the first shaft 102 around its circumference, allowing the shaft to move while maintaining a seal. The separator 103c is located approximately half-way down the height of the interior chamber 103 ensuring the upper and lower chambers 103a, 103b are approximately the same size.

The first shaft 102 has a first circular flange or piston 102a attached to it approximately a third of the way down the length of the shaft. The flange 102a extends radially outwards from the shaft towards the wall of the upper interior chamber 103a, where a ring seal 73 about the circumference of the flange forms a seal against the wall of the upper interior chamber. The first shaft is movable along its length such that the flange moves from a first position (i.e. a “retracted position” or “first heat-sealing plate position”) where it is contacting a ceiling of the upper interior chamber 103a to a second position (i.e. a “heat-sealing” position or “second heat-sealing plate” position) where it is contacting the upper surface of the interior separator 103c. Said movement of the shaft allows the length of the shaft protruding through the bottom of the external housing to be increased by approximately 18 mm as the shaft moves from the first position to the second position.

The first shaft 102 also has a hollow interior 102b. The hollow interior of the first shaft 102 allows for wiring and the like (not shown) to be guided down through the central housing.

The lower interior chamber 103b houses a second shaft 104, which runs coaxially with the first shaft 102, the second shaft being axially movable relative to the first shaft. The second shaft has a diameter of approximately 6 cm, and the first shaft runs through the centre of the second shaft as it travels through the lower interior chamber 103b, and a ring seal 77 internal to the second shaft 104 engages with the surface of the first shaft 102. When it is in its retracted position, shown in FIG. 2A, the second shaft extends from the lower surface of the interior divider 103c through the lower interior chamber 103b and through the bottom surface of the external housing 101. The second shaft exits the bottom surface of the external housing through a lower opening, the lower opening having about its periphery a ring seal 76 which engages with the surface of the second shaft. The second shaft 104 has a second circular flange 104a attached to it at its upper end, which extends radially out from the second shaft towards the wall of the lower interior chamber 103b. The second flange 104a has around its circumference a ring seal 74 which engages with the wall of the lower interior chamber 103b. The second shaft 104 is movable along its length from a first position (i.e. a “retracted position” or “first cutting blade position”) where the second flange 104a contacts the lower surface of the interior divider 103c to a second position (i.e. a “second cutting blade position”) where the second flange contacts the floor of the lower interior chamber 103b. Said movement of the second shaft 104 allows the length of the shaft protruding through the bottom of the external housing to be increased by approximately 18 mm as the shaft moves from the first position to the second position.

The second flange 104a located on the second shaft 104 has a pin 104b which projects down approximately 10 mm into the lower interior chamber 103b. The floor of the lower interior chamber has a corresponding recess 103d, of approximately 10 mm in depth, configured to receive the pin 104b when the second shaft is moved to its second position and the pin is aligned with the recess.

The second shaft 104 may be rotatable so as to move the pin 104b so that it is no longer aligned with the recess 103d. When the pin is not aligned with the recess, the movable range of the second shaft is reduced, i.e. it has a second movable range. In such a configuration, the second shaft 104 may be moved from the first position (i.e. the first cutting blade position) where the second flange 104a contacts the lower surface of the interior divider 103c to a third position (i.e. a “third cutting blade position”) where the pin contacts the floor of the lower interior chamber 103b. The movable range of the second shaft 104 is thereby reduced by a distance equal to the height of the pin 104b, i.e. 10 mm, to a total movable range of 8 mm.

The second shaft may have an SKF lock nut which is loosened to allow the shaft to be rotated to misalign the pin 104b and recess 103d. The shaft is then rotated through 45°. At the end of the second shaft is a marker 123a to indicate the selected stroke or function (inside cut or outside cut), the base of the housing 101 has two corresponding markings 123b, 123c to indicate which stroke or function is selected. The selection is performed during the assembly of the sealing tool, with the appropriate blade size being selected for the size of cut needed (a larger blade being needed for outside cut, where the blade has to fit around the perimeter of a tray and a smaller blade being needed for an inside cut where the blade is slightly smaller than the perimeter of the tray). The second shaft has four screw holes 126a, 126b, 126c, 126d, spaced at 90° intervals about the lower surface of the second shaft. The mounting holes of blade part 121 are positioned so that a blade designed for inside cut will only fit on the end of the second shaft, around the perimeter of the heat sealing plate, when the inside cut function is selected. Similarly, the mounting holes of blade part 121 are positioned so that a blade designed for an outside cut will only fit on the end of the second shaft, around the perimeter of the heat sealing plate, when the outside cut function is selected.

When both the first and second shafts 102, 104 are in their raised positions, the bottom of the first shaft 102 is lower than the bottom of the second shaft 104. Similarly, when both the first and second shafts 102, 104 are in their lowered positions, the bottom of the first shaft 102 is lower than the bottom of the second shaft 104.

Both first and second shafts 102, 104 may be pneumatically controlled. In order to move the first shaft from the first position, shown in FIG. 2A, in which the first flange 102a contacts the ceiling of the upper interior chamber 103a, to the second position, shown in FIG. 2B, in which the first flange contacts the upper surface of the interior divider 103c, a gas, such as air is injected under pressure above the first flange 102a. To move the first shaft 102 back to the first position, a gas is injected under pressure below the first flange. The gas is provided to these regions of the upper interior chamber 103a by first and second ports 112a, 112b through the upper surface of the housing 101. The first port 112a communicates via a conduit with the upper interior chamber 103a through an opening in the ceiling of the upper interior chamber 103a. The second port 103b communicates via a conduit with the side surface of the upper interior chamber 103a, proximate the interior divider 103c. Similarly, for the second shaft 104, to move the shaft from the first position, shown in FIG. 2B, in which the second flange 104a contacts the lower surface of the interior divider 103c, to the second position, shown in FIG. 2C, in which the second flange contacts the floor of the lower chamber 103b, a gas is injected under pressure above the second flange 104a. To move the second shaft back to the first position a gas is injected under pressure below the second flange. The above described ring seals 71 to 76 ensure that the injected gas efficiently communicates an actuating force to the first and second shafts 102, 104. The gas is provided to these regions of the lower interior chamber 103b by third and fourth ports 114a, 114b through the side surface of the housing 101. The third port 114a communicates via a conduit with the side surface of the lower interior chamber 103b, proximate the interior divider 103c. The fourth port 114b communicates via a conduit with the side surface of the lower interior chamber 103b, proximate the floor of the lower chamber 103b.

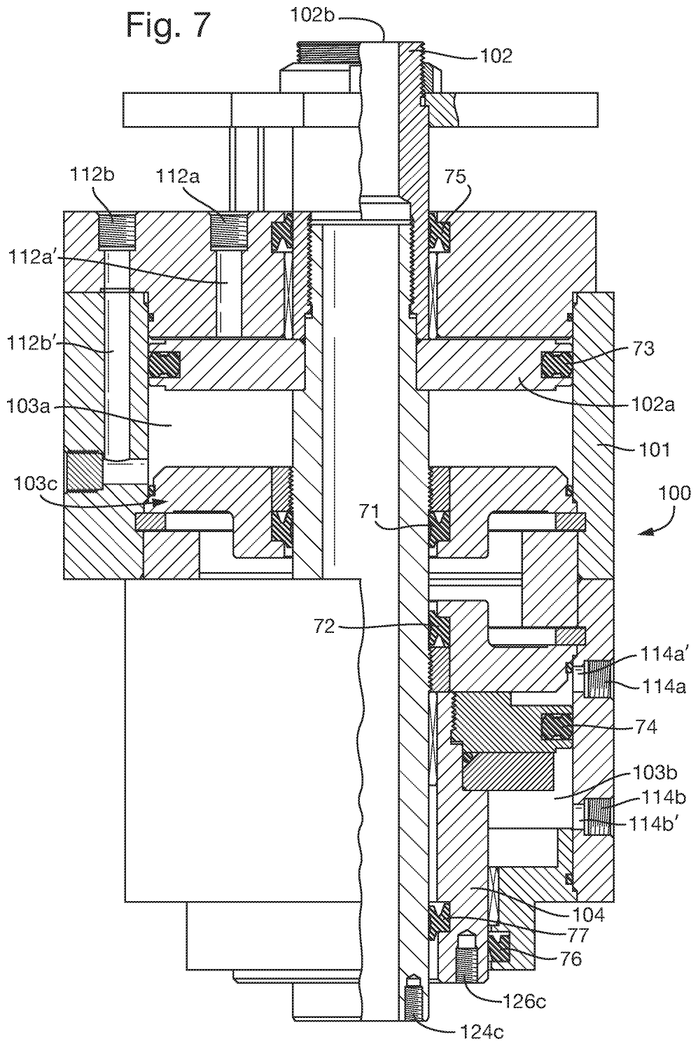

The first, second, third and fourth ports 112a, 112b, 114a, 114b are also shown in FIG. 7, which shows a partial section view of a sealing module according to an embodiment similar to those of FIGS. 2A to 2D. FIG. 7 shows that each port 112a, 112b, 114a, 114b communicates with the relevant interior chambers via a respective conduit 112a′, 112b′, 114a′, 114b′.

A heat-sealing plate 110 is attached to the bottom of the first shaft 102. The heat-sealing plate may be any heat-sealing plate suitable for sealing a film 4 to a tray 5, and many such heat-sealing plates are known in the art. Such heat-sealing plates generally have a heating element that matches the perimeter of a tray to be sealed, and welds the film to the rim of the tray. The heat-sealing plate 110 is held in a horizontal orientation by the first shaft 102 a short distance below the external housing 101. Wiring needed, for example, to provide electricity to the heat-sealing plate, may advantageously be connected to the rear of the heat-sealing plate through the hollow interior 102b of the first shaft 102. The heat sealing plate is held in place on the end of the first shaft 102 by six screws (not shown) received in corresponding screw holes 124a-f in the bottom surface of the first shaft.

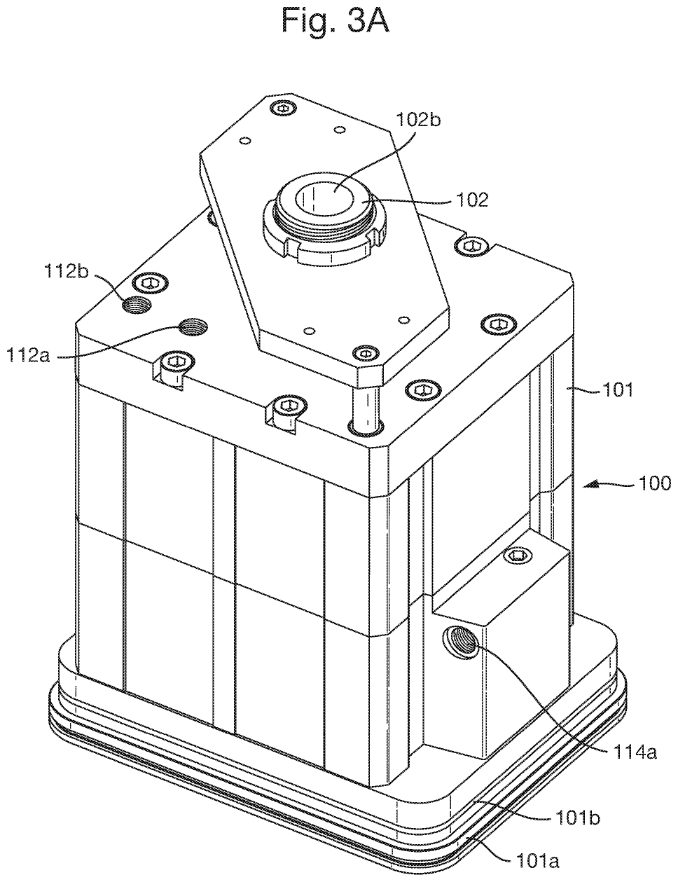

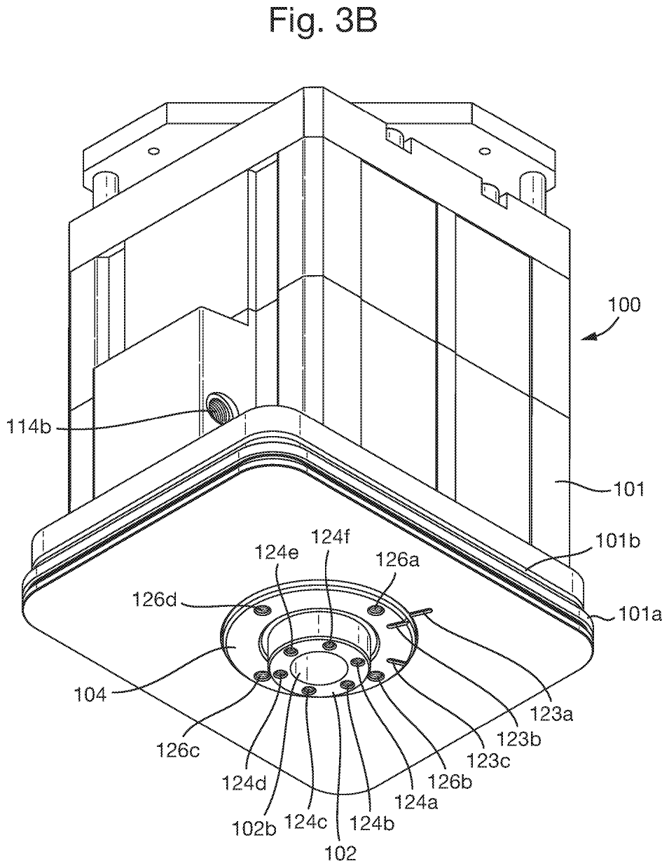

A cutting blade assembly 120 is attached to the bottom of the second shaft 104. The cutting blade assembly has a frame 121 in the form of a horizontal plate which is screwed directly to the second shaft using four screws, two of which 125a, 125c are shown in FIG. 2A. The screws are received by four corresponding screw holes 126a, 126b, 126c, 126d, shown in FIGS. 2B to 3B. The frame is located between the top of the heat-sealing plate 110 and the bottom of the external housing 101 and has a hole through its centre which allows the first shaft 102 to pass through and connect to the heater plate 110. A vertical blade 122 is connected to the frame 121, the blade following the perimeter of the heat-sealing plate 110 at a position spaced away from the heat sealing plate.

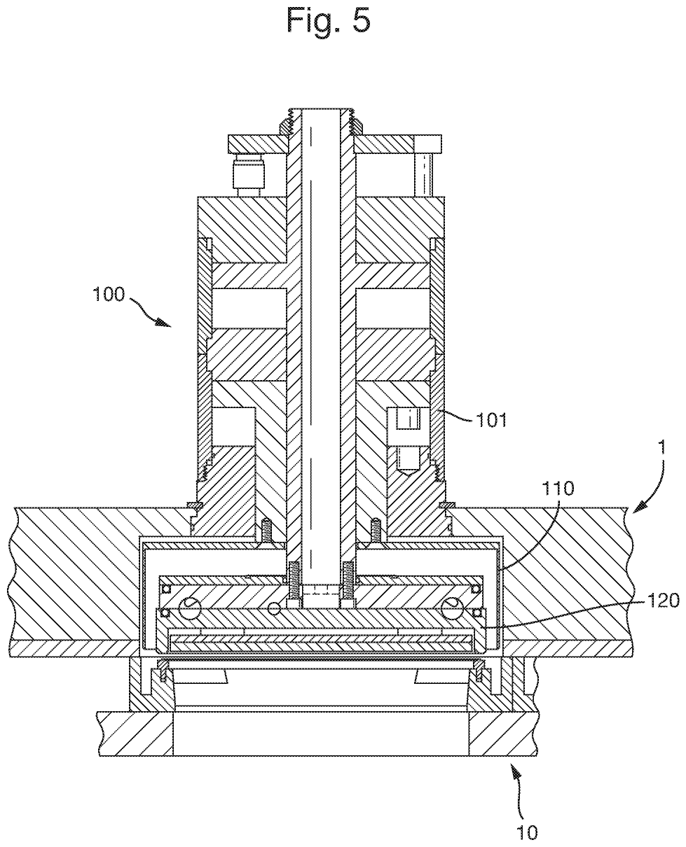

The way in which a sealing module 100 is mounted to the sealing module support will now be described in detail with reference to FIGS. 1 to 5. A heat-sealing plate 110 will commonly have a foot print larger than the footprint of the above described external housing 101. The cutting blade assembly 120 will have a footprint larger still than the heat-sealing plate 110, owing to the way in which the blade 122 extends around the outside of the perimeter of the heat-sealing plate 110. The sealing tool assembly is therefore designed such that each sealing module 100 is inserted up into an opening 3 of the sealing module support 1.

The base of the external housing 101 has a small lip 101a which protrudes horizontally outwards. As the sealing module 100 is inserted into the opening 3, the lip 101a abuts the second, smaller overhang 3b of the opening 3. This overhang 3b engaging with the lip 101a ensures that the external housing 101 is correctly positioned in the opening 3 and cannot be over-inserted. When the sealing module 100 is correctly positioned, the larger overhang 3a of the opening 3 accommodates beneath it the larger heat-sealing plate and the cutting blade assembly. This ensures that, when the first and second shafts are fully retracted, the heat-sealing plate 110 and cutting blade assembly 120 sit entirely above the bottom surface 1b of the sealing module support 1.

Each external housing 101 has a horizontal groove 101b along its sides, just above the lip 101a. When the module 100 is inserted into the opening 3 and is positioned relative to the smaller overhang, the grooves 101b are located in-line with the upper surface 1c of the sealing module support. The sealing module is then retained in position by retainers 8 which are inserted into the undercut on at least two sides. The retainer in this case is two U-shaped plates which are slid into grooves from two opposite sides of the sealing module, and between them secure the module from all four sides. The retainers 8 sit partially on the upper surface of the sealing module support 1 and partially in the grooves 101b in the external housing 101 ensuring that the sealing module is firmly secured. The retainers 8 may be fixed in place on the upper surface 1c of the sealing module support 1 by, for example, a quick release catch or bolts (not shown).

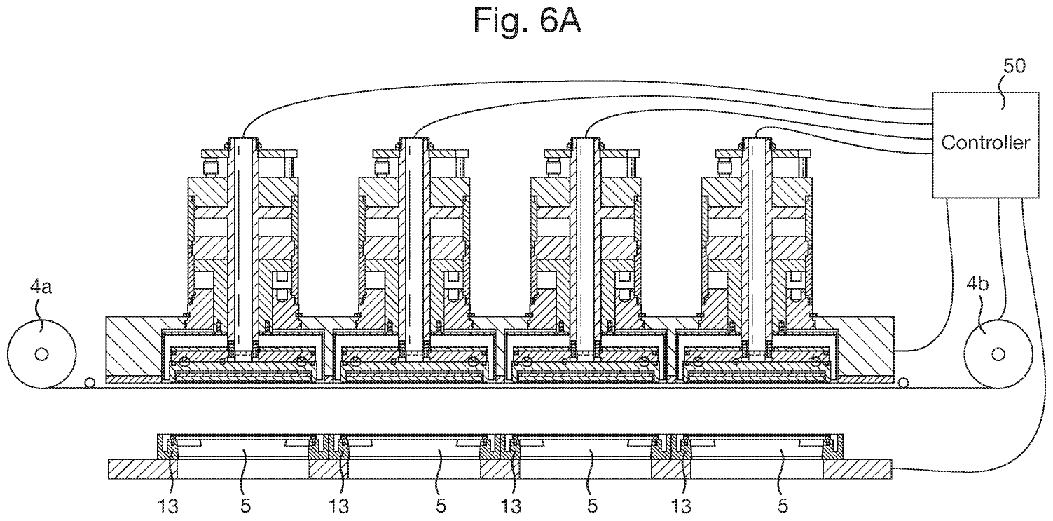

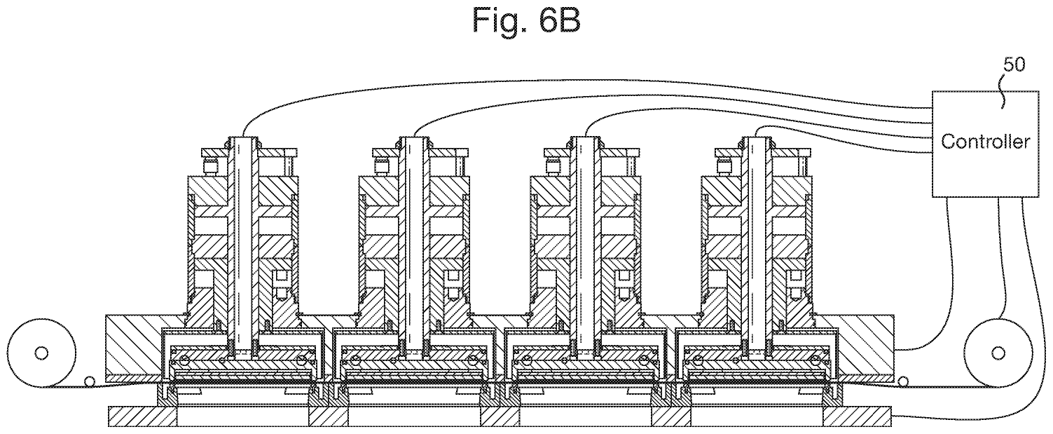

The operation of the heat-sealing tool will now be described with reference to FIGS. 6A and 6B. Before general operation of the sealing tool assembly can begin, the sealing tool assembly must be provided to a sealing apparatus (not shown), the operation of which is to be controlled by a controller 500 (shown schematically). The sealing apparatus may be any sealing apparatus known in the art which can accommodate the dimensions of the presently described sealing tool. The sealing module support 1 is provided to an upper tool handling portion of the sealing apparatus. The sealing module support 1 is then loaded with a plurality of heat sealing modules 101, each located in a respective opening 3. The lower tool 10 is then provided to a lower tool handling portion of the sealing apparatus. While it is described above that the sealing modules 100 are mounted on the sealing module support 1 after the support has been provided to a sealing apparatus, the sealing modules 100 may alternatively be secured to the sealing module support 1 prior to its provision to the sealing apparatus.

Once, the sealing tool assembly is provided to the sealing apparatus, as previously described, a film 4 is positioned horizontally between the support 1 and the lower tool 10, which are initially held in the spaced apart position shown in FIG. 6A. The film will typically originate from a film reel 4a, from which it unwinds and passes between the support 1 and lower tool 10 and winds onto a waste reel 4b.

Operation of the sealing tool assembly begins with a plurality of trays 5 to be sealed being moved into respective tray holders 13 in the lower tool. The means for moving trays into and out of the tray holders 13 is not shown in FIGS. 6A and 6B, but may be any means for moving trays, including for example tray grippers which are generally known in the art. The lower tool 10 is then raised towards the upper tool until the second lip 13d of the tray holder 13 contacts the lower surface 1b of the support 1, clamping the film 4 therebetween. At this point, shown in FIG. 6B, the tray 5 sits just below the film 4, and the sealing module is operated to perform a tray seal, which can be effected in a number of different ways.

A first sealing ‘stroke’ will now be described. The sealing module 100 can be configured to perform a seal with an “outside cut”. In this configuration, the first shaft 102 is actuated to bring the heat-sealing plate 110 down towards the tray 5. This actuation is the above described movement of the first shaft 102 from the first position to the second position. As it arrives at the second position, the heat-sealing plate 110 urges the film 4 against the rim of a tray 5 and effects the welding. The second shaft 104 is then actuated to perform an outside cut. To increase the speed of sealing, the second shaft may be actuated before the first shaft has stopped moving. This actuation is the above described movement of the second shaft from the first position to the second position. Importantly, the module is configured such that pin 104b is received by the recess 103d so that the second shaft has its full movement range available. The cutting blade 122 is moved by actuation of the second shaft 104 so much so that it passes through the film 4, around the rim of the tray 5, cutting it, and is received in the large groove 13c between the first and second lips 13b, 13d in the tray holder 13. This is referred to as an “outside cut” because the area of the film 4 on the tray 5 is slightly larger than the area of the top of the tray 5. That is to say, an amount of un-welded film extends slightly beyond the rim of the tray 5 on all sides.

A second sealing stroke will now be described. In a second configuration, the sealing module 100 cuts the film before sealing it. Prior to operation, the second shaft 104 of each sealing module 100 is orientated in the rotated position such that the pin 104b is not aligned with the recess 103d, and therefore the movable range of the second shaft 104 is restricted. Because the film 4 is to be cut before it has been sealed to a tray, the film will be cut while held above the tray. The cutting blade assembly 120 can therefore cut the film without extending down below the rim of the tray. Since the cutting blade 122 does not need to be able to pass around the edge of the tray 5, a cutting blade assembly 120 can be attached to the second shaft (prior to operation) which has a cutting blade 122 that more closely follows the perimeter of the heat-sealing plate 110. This advantageously allows the sealing module 100 to be configured to perform an “inside cut”. To perform the inside cut, the second shaft is actuated first to cut the film which is clamped between the support 1 and the lower tool 10. Because of the movement restrictions imposed on the second shaft by the pin 104b contacting the floor of the lower chamber 103b, the cutting blade stops above the tray 5. Immediately after the film is cut, i.e. almost simultaneously with actuation of the second shaft, the first shaft is actuated and the heat-sealing plate collects the cut film and presses it against the tray 5 to effect the welding. The resulting cut-seal stroke, in combination with the smaller cutting blade assembly, results in the above mentioned inside cut, in which the film 4 may be flush with or smaller than the perimeter of the tray 5, giving an overall neater appearance and reducing the chance of unintentional peeling of the film.

While the above described second sealing stroke is described with reference to an inside cut, it will be appreciated that the sealing stroke could also be used to perform an outside cut. That is to say, the larger cutting blade assembly 120, i.e. the same cutting blade assembly used in performing the first sealing stroke, could be used for the second sealing stroke. This would result in an outside cut due to a larger area of film being cut by the blade 122.

Once a tray seal has been performed the lower tool 10 is lowered away from the sealing module support 1, and the trays 5 passed downstream by means (not shown) such as grippers. The remainder of the film 4 is then wound on between the film reel and the waste reel and a plurality of trays to be sealed are passed to the lower tool so that the process may continue.

In a situation in which one of the plurality of sealing modules 100 develops a fault during use and is unable to operate as required, the controller 500 may continue to operate the sealing apparatus without using the faulty sealing module. Once use of the sealing apparatus has ceased, for example, at the end of a day, the faulty sealing module 100 may be removed from the sealing module support 1 and replaced with a new sealing module. Removal of a sealing module simply requires clearance below the support 1, and removal of the retainer 8 before the faulty module can be conveniently removed down through the opening 3. Advantageously, this is a much quicker process than fixing a conventional upper tool which develops a fault, and is much more cost effective than replacing an entire upper tool due to a fault with only one of a plurality of sealers. The process is in fact so quick that it may be worthwhile to stop use of a sealing apparatus in which one of the plurality of modules 100 has developed a fault and replace it immediately so that the sealing apparatus can function at full capacity for the remainder of its uptime.

1. A sealing tool module, the sealing tool module comprising:
a housing;
a heat-sealing plate; and
a first actuator for use in moving said heat-sealing plate between a retracted position and a heat-sealing position, the first actuator being movably mounted with respect to the housing; wherein
the first actuator is a first shaft on the end of which the heat-sealing plate is mounted, the first shaft being axially movable relative to the housing; and
the first shaft comprises a channel configured to guide wiring through the housing and to the rear of the heat-sealing plate.

2. A sealing tool module according to claim 1, wherein the movement of the heat-sealing plate between the retracted position and the heat-sealing position is pneumatically or hydraulically controlled and/or movement of the heat-sealing plate between the heat-sealing position and the retracted position is pneumatically or hydraulically controlled.

3. A sealing tool module according to claim 1, wherein the channel is internal to the first shaft, and preferably extends internally along the entire length of the shaft.

4. A sealing tool module according to claim 1, further comprising a cutting blade, and a second actuator movably mounted within the housing for use in moving the cutting blade between a retracted position and an extended position, and wherein the cutting blade extends substantially around the perimeter of the heat-sealing plate.

5. A sealing tool module according to claim 4, wherein the second actuator is a second shaft on the end of which the cutting blade is mounted, wherein moving the cutting blade comprises axially moving the second shaft, and wherein the second shaft is axially movable relative to the first shaft and the housing.

6. A sealing tool module according to claim 5, wherein each sealing module may be switched from a first configuration to a second configuration, wherein in a first configuration the second shaft has a first movable range, and in the second configuration the second shaft has a second movable range different from the first movable range.

7. A sealing tool module according to claim 6, wherein the second shaft is rotatable relative to the housing so as to switch between the first configuration and the second configuration.

8. A sealing tool module according to claim 6, further comprising a stop, the stop being movable with respect to the housing between first and second positions for switching between the first configuration and the second configuration, the stop causing engagement between the second shaft and the housing in at least one of the first and second positions, and thereby affecting the movable range of the second shaft.

9. A sealing tool module according to claim 6, wherein in the first configuration a stop on one of the second shaft or an interior surface of the housing is received in a recess in the other of the second shaft and the interior surface of the housing thereby permitting the first movable range of the second shaft, and in the second configuration the stop on one of the second shaft or the interior surface of the housing is not received in the recess in the other of the second shaft and the interior surface of the housing thereby permitting the second movable range of the second shaft.

10. A sealing tool module according to claim 6, wherein, in use, the first and second configurations are used for different sealing-and-cutting strokes, and wherein preferably the first configuration is an outside-cut configuration and the second configuration is an inside-cut configuration.

11. A sealing tool module according to claim 5, wherein in an outside-cut configuration the first actuator is configured to move the heat-sealing plate from a first heat-sealing plate position to a second heat-sealing plate position lower than the first heat-sealing plate position, and the second actuator is configured to move the cutting blade from a first cutting blade position to a second cutting blade position lower than the first cutting blade position, wherein in the second cutting blade position a cutting edge of the cutting blade is lower than the heat-sealing plate in the second heat-sealing plate position, wherein, in use, the heat-sealing plate is moved from the first heat-sealing plate position to the second heat-sealing plate position so as to perform a heat seal, and the cutting blade is moved from the first cutting blade position to the second cutting blade position so as to perform a cut, and wherein the heat-sealing plate arrives at the second heat-sealing position before the cutting blade arrives at the second cutting blade position so that the sealing module performs a seal-cut stroke.

12. A sealing tool module according to claim 5, wherein in an inside-cut configuration the first actuator is configured to move the heat-sealing plate from a first heat-sealing plate position to a second heat-sealing plate position lower than the first heat-sealing plate position, and the second actuator is configured to move the cutting blade from a first cutting blade position to a third cutting blade position lower than the first cutting blade position, wherein in the third cutting blade position a cutting edge of the cutting blade is higher than the sealing plate in the second sealing plate position, wherein, in use, the cutting blade is moved from the first cutting blade position to the third cutting blade position to perform a cut, and the heat-sealing plate is moved from the first heat-sealing plate position to the second heat-sealing plate position to perform a seal, and wherein the cutting blade arrives at the third cutting blade position before the heat-sealing plate arrives at the second heat-sealing plate position so that the sealing module performs a cut-seal stroke.

13. A sealing tool assembly for heat sealing a cover film to a container, the assembly comprising:
a sealing module support having a plurality of openings therethrough; and
a plurality of sealing modules, each according to any of claims 1 to 12 and each disposed in a respective one of the plurality of openings and configured to independently perform heat sealing;
wherein each of the plurality of sealing modules is removable from the sealing module support independently of the other sealing modules.

14. A sealing tool assembly according to claim 13, wherein each sealing module is insertable into a respective opening of the sealing module support, and retainable there by engagement between its housing and the sealing module support via at least one retention member, wherein preferably the module is insertable up into the opening and removable down through the opening.

15. A sealing tool module, the sealing tool module comprising:
a housing;
a heat-sealing plate;
a first actuator for use in moving said heat-sealing plate between a retracted position and a heat-sealing position, the first actuator being movably mounted with respect to the housing;
a cutting blade, the cutting blade extending substantially around the perimeter of the heat-sealing plate; and
a second actuator movably mounted within the housing for use in moving the cutting blade between a retracted position and an extended position;
wherein the sealing module may be switched from a first configuration to a second configuration, wherein in a first configuration the second actuator has a first movable range, and in the second configuration the second actuator has a second movable range different from the first movable range.
